(19) United States
(12) Patent Application Publication
(10) Pub. No.: US 2017/0210527 A1
(43) Pub. Date: Jul. 27, 2017

(54) TIE STRIP DEVICE AND METHOD

(71) Applicant: CHARLES BREELING, PORTLAND, TX (US)

(72) Inventor: CHARLES BREELING, PORTLAND, TX (US)

(21) Appl. No.: 15/418,661

(22) Filed: Jan. 27, 2017

Related U.S. Application Data
(60) Provisional application No. 62/287,543, filed on Jan. 27, 2016.

(51) Int. Cl. B65D 63/10; B65D 63/16; E05B 75/00; F16B 1/02

(52) U.S. Cl. CPC B65D 63/1063; F16B 1/02; B65D 63/16; E05B 75/00

(57) ABSTRACT

A tie strip system including a tie-strip assembly, with the tie-strip assembly including a linear-body, with the linear-body including a top-side, a bottom-side, and two ends. Also included are two body-ratchets coupled to the top-side of the linear-body nearest a center of the linear-body, each of the two body-ratchets arranged to accept one of the two ends of the linear-body to provide a loop useful for maintaining one or more objects in a fixed position. Two or more tie-strip assemblies may be removably coupled to each other such that a user may select the number of tie-strip assemblies during use. The tie-strip assembly is color-coded such that a user may easily identify the type object maintained in a fixed position, and may be constructed from non-electrically conductive materials.

### CROSS-REFERENCE TO RELATED APPLICATION

The present application is related to and claims priority to U.S. Provisional Patent Application No. 62/287,543 filed Jan. 27, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

1. Field of the Invention

The present invention relates generally to the field of buckles, buttons, and clasps of the existing art and more specifically relates to binder tightening and joining implements.

2. Description of Related Art

A cable tie or tie-wrap, which may also be referred to as a hose tie, zip-tie, or zap strap, is a type of fastener, for holding items together, primarily electric cables or wires, electrical conduit or pipes. Some applications may also include law enforcement activities as an inexpensive replacement for standard hand-cuffs.

The common tie, normally made of a nylon material or plastic, has a flexible section with teeth that engage with a pawl in a head to form a ratchet such that the free end of the tape section can be pulled such that the tie tightens.

In certain industries, such as construction, where a multitude of cables and bundles of cables are used, the cables generally must be arranged and organized in a correct manner. In instances where two separate bundles of cables are held together by a single tie, problems may arise. When one of the bundles needs to be accessed, the original tie must be cut, disposed of, and replaced. This type of use adds additional time and cost to the overall work task at hand. Furthermore, if a law enforcement or security officer uses a similar tie to constrain an apprehended individual, the individual may still be able flee with his or her hands tied. A suitable solution is desired.

U.S. Pat. No. 6,119,314 to Anna B. Freed relates to a multi-function tie. The described multi-function tie includes a tie which can be releasable or non-releasable, tie one bundle or two bundles, be threaded from either side, have a circular or oval shape, have controlled release, and attach to other ties so two or more ties can be opened in unison. Each releasable tie has a strap, a holder, and a retainer, which can be in a locked or unlocked position. In the locked position, the tie can tighten in discrete increments, but cannot loosen. In the unlocked position, the tie can loosen or release in discrete increments (i.e., controlled release), but cannot tighten. The retainer and holder engage to keep the tie in either a locked or unlocked position. Two or more ties may be attached so that the user can lock or unlock in unison.

### BRIEF SUMMARY OF THE INVENTION

In view of the foregoing disadvantages inherent in the known buckles, buttons and clasps art, the present disclosure provides a novel tie strip system and method. The general purpose of the present disclosure, which will be described subsequently in greater detail, is to provide a tie strip system and method to allow a user with the flexibility to fasten additional objects into an already bundled object or affix multiple objects during different periods of time without the need to remove the initial tie.

A tie strip system is disclosed herein. The tie strip system includes a tie-strip assembly, and two body-ratchets. The tie-strip assembly includes a linear-body, with the linear-body including a top-side, a bottom-side, and two ends. The body-ratchets are coupled to the top-side of the linear-body nearest a center of the linear-body. Embodiments may also include body-ratchets affixed to one or more ends of the linear-body. Each of the body-ratchets are arranged to accept one of the two ends of the linear-body to provide a loop useful for maintaining one or more objects in a fixed position.

The top-side of the linear body includes a plurality of parallel grooves useful for securing the linear-body into the body-ratchets from a first-direction, and the bottom-side of the linear-body includes a plurality of parallel grooves useful for securing the linear-body into the body-ratchets from a second-direction. Such an arrangement allows a user to insert the linear-body into the body-ratchet in either direction (e.g., from an upper side, a lower side, etc.). The linear-body preferably includes ends which include a substantially triangular shape, to allow the linear-body to be easily inserted into a body-ratchet during use.

The tie strip system may include more than one tie-strip assembly coupled in a parallel fashion, with the tie-strip assemblies being removable from one another. As such, the user may remove tie-strip assemblies from the system in order to utilize the appropriate number of tie-strip assemblies according to specific job requirements and specific conditions. Also, the tie strip system may be constructed from tie-strip assemblies which are color-coded such that the user may easily identify the type object maintained in a fixed position by attaching the appropriate color of tie-strip assemblies to a specific object to be identified (e.g., internet wires, electrical wires, cable wires, hot water, cold water, etc.).

The tie strip system is preferably constructed from a non-electrically conductive material to provide improved safety as not to provide electrical interference with the one or more objects, and improve safety and reliability.

According to another embodiment, a method of use for a tie strip system is also disclosed herein. The method of use includes a first step; providing a tie strip system; a second step, providing at least one object; a third step, affixing the tie strip system to the at least one object to maintain one or more objects; a fourth step, providing a second object; a fifth step, affixing the tie strip system to the second object; and a sixth step, securing the second object in a fixed position. It must be noted that not all steps of the method of use are required in all instances, and all steps need not be performed in any particular order.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a tie strip system and method, constructed and operative according to the teachings of the present disclosure.

FIG. 1 is a perspective view of the tie strip system during an ‘in-use’ condition, according to an embodiment of the disclosure.

FIG. 2 is a perspective view of the tie strip system of FIG. 1, according to an embodiment of the present disclosure.

FIG. 3 is a perspective view of the tie strip system of FIG. 1, according to an embodiment of the present disclosure.

FIG. 4 is a perspective view of the tie strip system of FIG. 1, according to an embodiment of the present disclosure.

FIG. 5 is a flow diagram illustrating a method of use for a tie strip system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to buckles, buttons, and clasps and more particularly to a tie strip system and method as used to improve the ability of a user to bind and maintain objects in a fixed position.

Generally, the tie strip system is a system to tie cables, hoses, conduit, pipes, wires and/or other objects. The system allows a user to connect the tie strips end-to-end and/or side-to-side while allowing the user to cut the tie strips into custom quantities. The system provides a tie strip than can be connected to another tie strip that is already in use, or provide an anchor to an existing structure eliminating the need for nailing or gluing to the structure. The system may be packaged in a roll where the ties are attached back to back, or may be attached to allow the user to cut any number of units to allow the user to affix additional wires, cables, hoses, etc. without the need to remove or take down the existing ties.

The tie strip system is a system that combines a plurality of tie strips into a single unit. This system may comprise two high-strength plastic or other material ties connected to one another at a meeting point. A ratcheting mechanism may have notches on both sides to allow the tie to be inserted either way. The system may be constructed in any number of assemblies (e.g., allowing 2, 4, 6, 8, etc. assemblies to be combined).

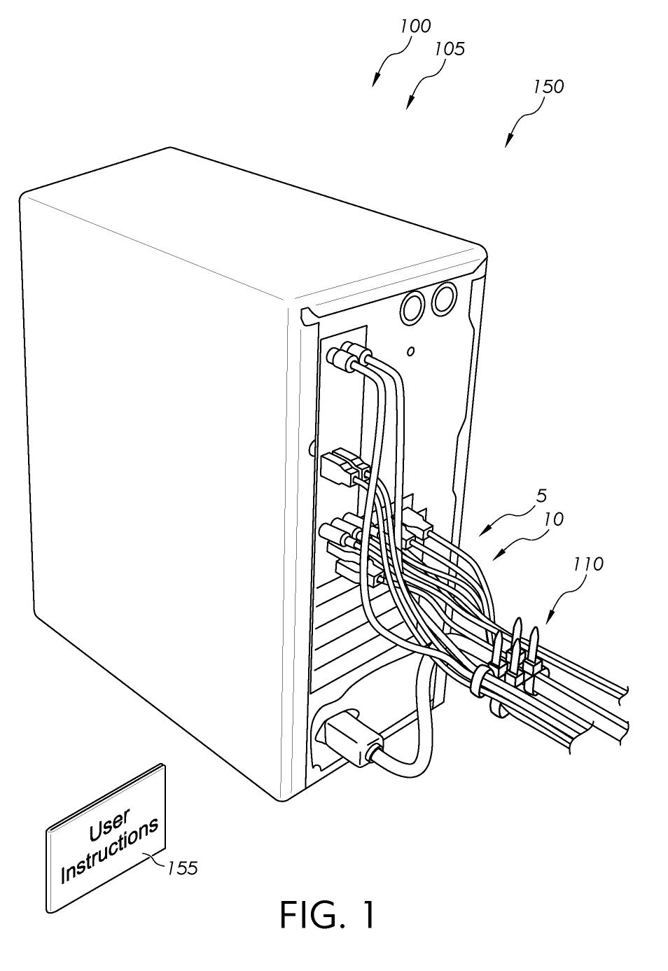

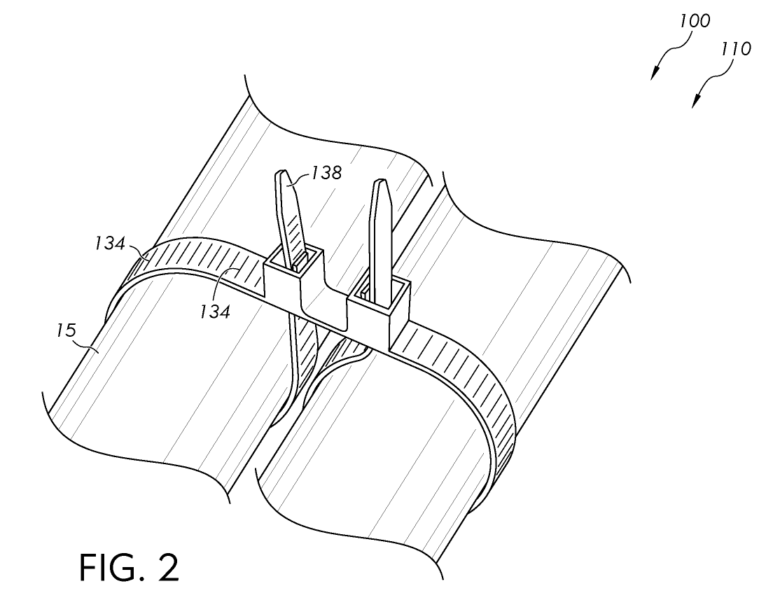

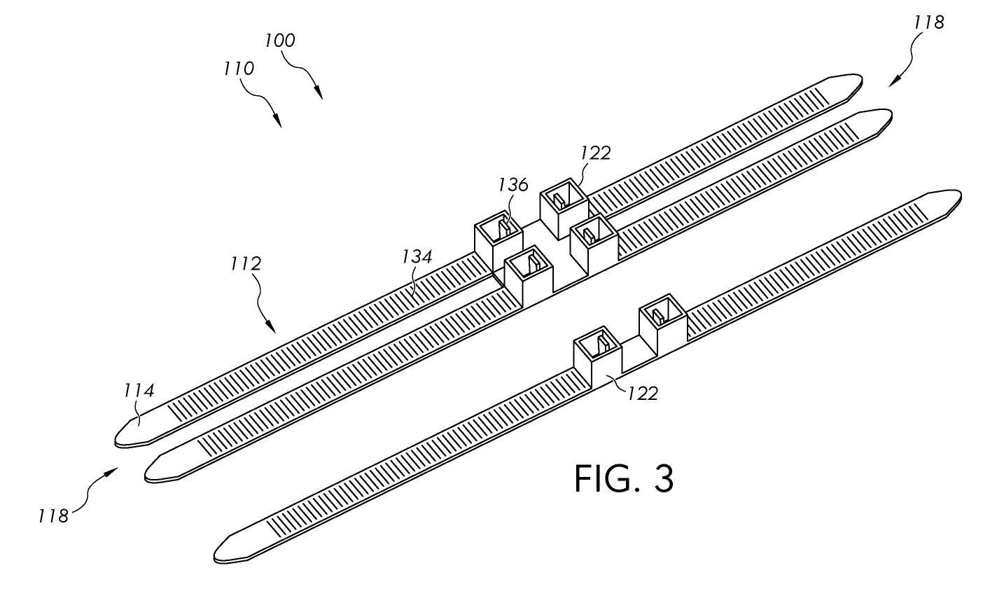

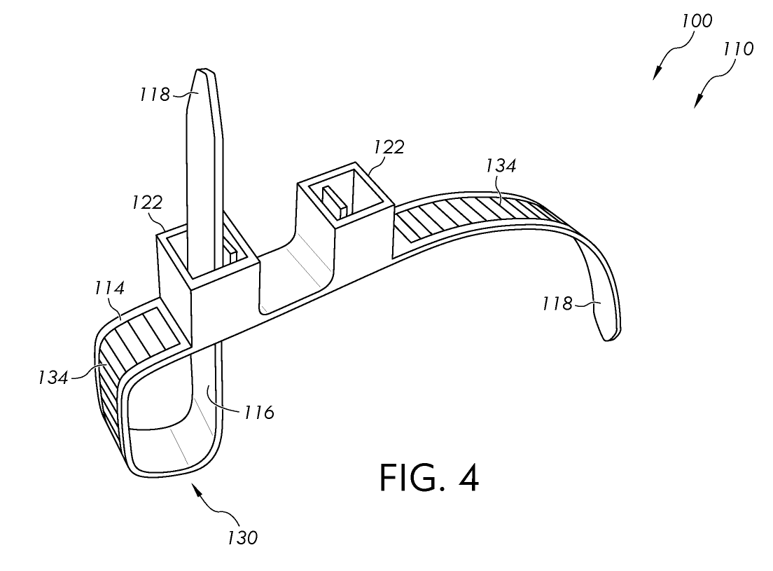

Referring now more specifically to the drawings by numerals of reference, there is shown in FIGS. 1-4, various views of a tie strip system 100. FIG. 1 shows a tie strip system 100 during an ‘in-use’ condition 150, according to an embodiment of the present disclosure. Here, the tie strip system 100 may be beneficial for use by a user to bundle and/or maintain object(s) 5 in (a) fixed position(s). As illustrated, the tie strip system 100 may include a tie-strip assembly 110 and two body-ratchets 122. Tie strip system may include one tie-strip assembly 110, or multiple tie-strip assemblies 110, according to embodiments. Accordingly, tie strip system 100 may include multiple body-ratchets 122 to coincide with multiple tie-strip assemblies 110.

Each tie-strip assembly 110 may include linear-body 112, wherein linear-body 112 may include top-side 114, bottom-side 116, and two ends 118. Each body-ratchet 122 may be coupled to top-side 114 of linear-body 112 nearest a center of linear-body 112. Each body-ratchet 122 may be arranged to accept one end of linear-body 112 to provide loop 130 useful for maintaining one or more objects 5 in a fixed position. In some embodiments, tie-strip assemblies 110 may be coupled in a parallel fashion to provide multiple tie-strip assemblies 110 coupled during use. Other embodiments may include tie-strip assemblies 110 coupled end-to-end. Embodiment may also include two or more tie-strip assemblies 110 removable from one another such that a user may select a number of tie-strip assemblies 110 during use, where tie-strip assemblies 110 may be assembled in a roll, sheet, or other dispensing means.

Top-side 114 of linear-body 112 may include a plurality of parallel-grooves 134 useful for securing linear-body 112 into body-ratchets 122 from a first-direction, or may alternatively or additionally include plurality of parallel grooves 134 useful for securing linear-body 112 into body-ratchets 122 from a second-direction such that linear-body 112 may be inserted into body-ratchet 122 from either side. Linear-body 112 may include ends 118 which include a triangular shape 138, to allow linear-body 112 to be easily inserted into body-ratchets 122 during use.

Body-ratchets 122 may be non-reversible such that linear-body 112 cannot be removed from body-ratchets 122, in some embodiments. Other embodiments may include body-ratchets 122 which may include a release such that linear-body 112 may be removed from body-ratchets 122 such that tie strip system 100 is easily removable from object 5, and therefore reusable.

Tie-strip assembly 110 may be color-coded such that the user may easily identify the type object 5 maintained in a fixed position, or alternate embodiments may include an opaque material such that tie strip system 100 is not easily noticeable during use. Tie strip system 100 may be constructed from a non-electrically conductive material to provide improved safety (from electrocution to a user, or short-circuiting, etc.) and not provide electrical interference with objects 5 bundled by tie strip system 100.

Tie strip system 100 may be used for a variety of objects 5, objects 5 may include (but not limited to) one or more electrical wires 10, one or more pipes 15, or one or more conduit. Embodiments and uses may also include the binding of the hands, wrists, legs or other body parts of individuals apprehended by law enforcement or security personnel. Tie strip system 100 may be used during initial construction phases, pre-construction phases, during rehabilitation construction phases, and/or remodeling during construction projects, in embodiments.

According to one embodiment, the tie strip system 100 may be arranged as a kit 105. In particular, the tie strip system 100 may further include a set of instructions 155. The instructions 155 may detail functional relationships in relation to the structure of the tie strip system 100 (such that the tie strip system 100 can be used, maintained, or the like, in a preferred manner).

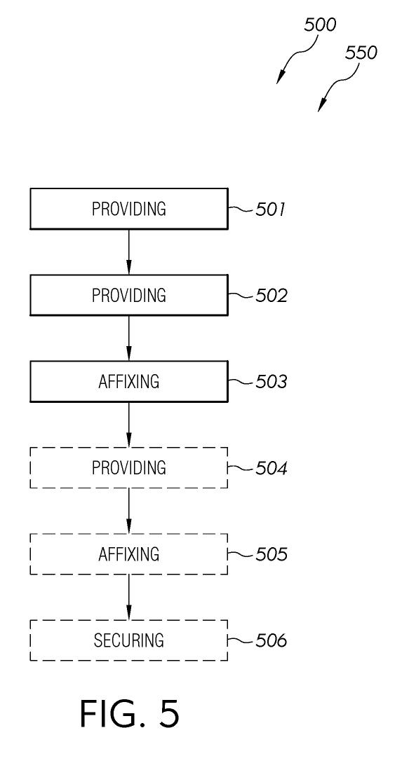

FIG. 5 is a flow diagram illustrating a method 500 for using a tie strip system 100, according to an embodiment of the present disclosure. In particular, the method 500 for using a tie strip system 100 may include one or more components or features of the tie strip system 100 as described above. As illustrated, the method 500 for using a tie strip system 100 may include the steps of: step one 501, providing tie strip system; step two 502, providing a first object; step three 503, affixing the tie strip system to the first object to maintain the first object in a fixed position; step four 504, providing a second object; step five 505, affixing the tie strip system to the second object; and step six 506, securing the second object in a fixed position.

It should be noted that step four 504, step five 505, and step six 506 are optional steps and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference.

The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using a tie strip system 100 (e.g., different step orders within above-mentioned list, elimination or addition of certain steps, including or excluding certain maintenance steps, etc.), are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A tie strip system, the system comprising:
a tie-strip assembly including a linear-body, said linear-body including a top-side, a bottom-side, and two ends; and
two body-ratchets coupled to said top-side of said linear-body nearest a center of said linear-body, each of said two body-ratchets arranged to accept one of said two ends of said linear-body to provide a loop useful for maintaining one or more objects in a fixed position.

2. The tie strip system of claim 1, wherein said top-side of the linear body includes a plurality of parallel grooves useful for securing said linear-body into the body-ratchets from a first-direction.

3. The tie strip system of claim 1, wherein the bottom-side of the linear body includes a plurality of parallel grooves useful for securing said linear-body into said body-ratchets from a second-direction.

4. The tie strip system of claim 1, wherein each of said body-ratchets are non-reversible such that said linear-body cannot be removed from said body-ratchets.

5. The tie strip system of claim 1, wherein each of said body-ratchets include a release such that said linear-body can be removed from said body-ratchets such that said tie strip system is easily removable from said object and therefore reusable.

6. The tie strip system of claim 1, wherein said tie strip system includes one tie-strip assembly.

7. The tie strip system of claim 1, wherein said tie strip system includes two or more tie-strip assemblies coupled in a parallel fashion.

8. The tie strip system of claim 7, wherein said two or more tie-strip assemblies are removable from one another such that a user may select the number of tie-strip assemblies for use.

9. The tie strip system of claim 1, wherein said tie-strip assembly is color-coded such that a user may easily identify the type object maintained in a fixed position.

10. The tie strip system of claim 1, wherein said tie strip system is constructed from an opaque material such that said tie strip system is not easily noticeable during use.

11. The tie strip system of claim 1, wherein said tie strip system is constructed from a non-electrically conductive material to provide improved safety and not provide electrical interference with said one or more objects.

12. The tie strip system of claim 1, wherein said linear body includes ends which include a substantially triangular shape, to allow said linear-body to be easily inserted into said body-ratchets.

13. The tie strip system of claim 1, wherein said one or more objects includes one or more electrical wires.

14. The tie strip system of claim 1, wherein said one or more objects includes at least one pipe.

15. The tie strip system of claim 1, wherein said one or more objects includes electrical conduit.

16. The tie strip system of claim 1, wherein said one or more objects includes at least one body part of a human individual.

17. A tie strip system, the system comprising:
a tie-strip assembly including a linear-body, said linear-body including a top-side, a bottom-side, and two ends;
two body-ratchets coupled to said top-side of said linear-body nearest a center of said linear-body, each of said two body-ratchets arranged to accept one of said two ends of said linear-body to provide a loop useful for maintaining one or more objects in a fixed position;
wherein said top-side of the linear body includes a plurality of parallel grooves useful for securing said linear-body into the body-ratchets from a first-direction;
wherein the bottom-side of the linear body includes a plurality of parallel-grooves useful for securing said linear-body into said body-ratchets from a second-direction;
wherein each of said body-ratchets include a release such that said linear-body can be removed from said body-ratchets such that said tie strip system is easily removable from said object and reusable;
wherein each of said body-ratchets include a release such that said linear-body can be removed from said body-ratchets such that said tie strip system is easily removable from said object and reusable;
wherein said two or more tie-strip assemblies are removable from one another such that a user may select the number of tie-strip assemblies for use;
wherein said tie-strip assembly is color-coded such that a user may easily identify the type object maintained in a fixed position;
wherein said tie strip system is constructed from a non-electrically conductive material to provide improved safety and not provide electrical interference with said one or more objects; and
wherein said linear body includes ends which include a substantially triangular shape, to allow said linear-body to be easily inserted into said body-ratchets.

18. The tie strip system of claim 17, further comprising set of instructions; and
wherein the system is arranged as a kit.

19. A method of use for a tie strip system, the method comprising the steps of:
providing a tie strip system;
providing a first object; and
affixing said tie strip system to said first object to maintain said first object in a fixed position.

20. The method of claim 19, further comprising the steps of:
providing a second object;
affixing said tie strip system to said second object; and
securing said second object in a fixed position.
